(19) United States
(12) Patent Application Publication
(10) Pub. No.: US 2015/0151555 A1
(43) Pub. Date: Jun. 4, 2015

(54) DETECTION MECHANISM FOR DETECTING POSITION OF PRINT MEDIUM

(71) Applicants: Qisda Optronics (Suzhou) Co., Ltd., Suzhou (CN); Qisda Corporation, Taoyuan (TW)

(72) Inventor: CHIU-AN HUANG, New Taipei City (TW)

(21) Appl. No.: 14/555,730

(22) Filed: Nov. 28, 2014

(30) Foreign Application Priority Data
Nov. 29, 2013 (TW) 102143848

(51) Int. Cl. B41J 11/00

(52) U.S. Cl. CPC B41J 11/0095

(57) ABSTRACT

A detection mechanism for detecting a position of a print medium. The detection mechanism includes a supporting member and a detector. The supporting member is for supporting the print medium and defined with a center point. The supporting member has a first section and a second section. The first section has a first distance to the center point. The second section has a second distance to the center point. The second distance is greater than the first distance. The detector is disposed in the second section and configured to generate a prompt message when detecting that the print medium is located in the second section. The print medium is located in the first section when the print medium has a size equal to or greater than a threshold. Alternatively, the print medium is located in the second section when the size of the print medium is smaller than the threshold.

### FIELD OF THE INVENTION

The present invention relates to a detection mechanism, and more particularly to a detection mechanism having less complicate structure and higher accuracy and is used for detecting a position of a print medium.

### BACKGROUND OF THE INVENTION

In a conventional printer, a sensor is installed next to a roll paper. The sensor will be triggered to generate prompt signal, such as “paper roll is about to run out”, when the remaining volume (or, the remaining size) of the roll paper is less than a specified value. However, the supporting element configured to support the roll paper is usually designed to have an arcuate structure; thus, the roll paper may shake in the arcuate structure and consequentially the sensor may have a poor accuracy. To overcome this issue, a conventional printer may be further installed with a shaft passing through the hollow sleeve barrel of the roll paper thereby avoiding the poor accuracy of the sensor resulted from the unexpected shake. However, an additional mechanism for driving the shaft is required; as a result, the conventional printer may have s higher cost and may be easily broken down or be out of order due to its complicate structure.

### SUMMARY OF THE INVENTION

Therefore, one object of the present invention is to provide a detection mechanism with less complicate structure and higher accuracy and is used for detecting a position of a print medium thereby overcome the aforementioned issue.

The present invention provides a detection mechanism configured to detect a position of a print medium. The detection mechanism includes a supporting member and at least a detector. The supporting member is configured to support the print medium and defined with a center point. The supporting member has a first section and a second section. The first section has a first distance to the center point. The second section has a second distance to the center point. The second distance is greater than the first distance. The detector is disposed in the second section and configured to generate a prompt message when detecting that the print medium is located in the second section. The print medium is located in the first section when the print medium has a size equal to or greater than a threshold. Alternatively, the print medium is located in the second section when the size of the print medium is smaller than the threshold.

The supporting member in the present invention is designed to have a plurality of sections with specific structure characteristics (such as a distance to a center point or a height to a base). Thus, the print medium is located in different sections on the supporting member with the decrease of the remaining volume (or, the remaining size) of the print medium; and correspondingly a detector or a sensor can be triggered to remind or alter or alert a user to replace the print medium when the print medium is about to run out.

For making the above and other purposes, features and benefits become more readily apparent to those ordinarily skilled in the art, the preferred embodiments and the detailed descriptions with accompanying drawings will be put forward in the following descriptions.

### BRIEF DESCRIPTION OF THE DRAWINGS

FIG. 1 is schematic cross-sectional view of a part of a printer in accordance with an embodiment of the present invention;

FIG. 2 is schematic cross-sectional view of a detection mechanism in accordance with an embodiment of the present invention;

FIGS. 3, 4 are schematic cross-sectional views of a detection mechanism with a print medium loaded in accordance with an embodiment of the present invention;

FIG. 5 is a schematic cross-sectional view of a detector in accordance with another embodiment of the present invention;

FIG. 6 is a schematic cross-sectional view of a detector in accordance with another embodiment of the present invention;

FIGS. 7, 8 are schematic cross-sectional views of a detection mechanism with a print medium loaded in accordance with an embodiment of the present invention;

FIG. 9 is schematic cross-sectional view of a detection mechanism in accordance with another embodiment of the present invention; and

FIG. 10 is schematic cross-sectional view of a detection mechanism in accordance with another embodiment of the present invention.

### DETAILED DESCRIPTION OF PREFERRED EMBODIMENTS

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

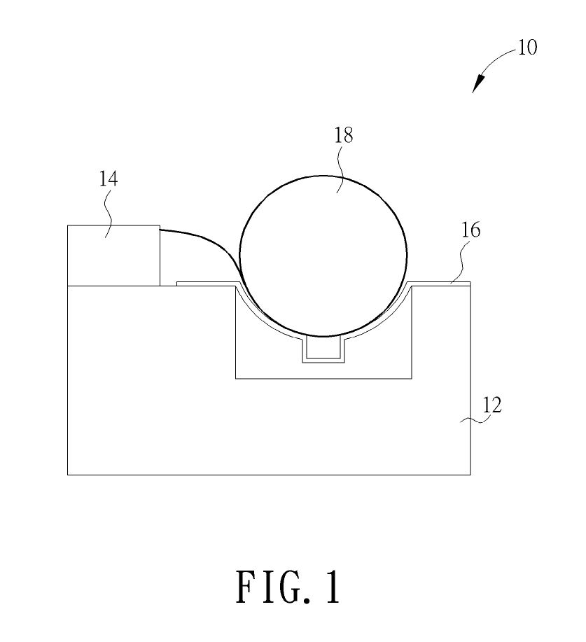

FIG. 1 is schematic cross-sectional view of a part of a printer 10 in accordance with an embodiment of the present invention. As shown, the printer 10 in the present embodiment includes a base 12, a print module 14, a detection mechanism 16 and a print medium 18. The print module 14 and the detection mechanism 16 are disposed on the base 12. The print medium 18 is movably placed on the detection mechanism 16. The print medium 18 is a replaceable consumable such as a paper roll. The print module 14 is configured to roll out the print medium 18 (a paper roll) for printing. During the printing process, the detection mechanism 16 is configured to detect the remaining volume (or, the remaining size) of the print medium 18 and timely remind or alert a user to replace the print medium 18 (a paper roll) according to the volume change of the print medium 18 (a paper roll).

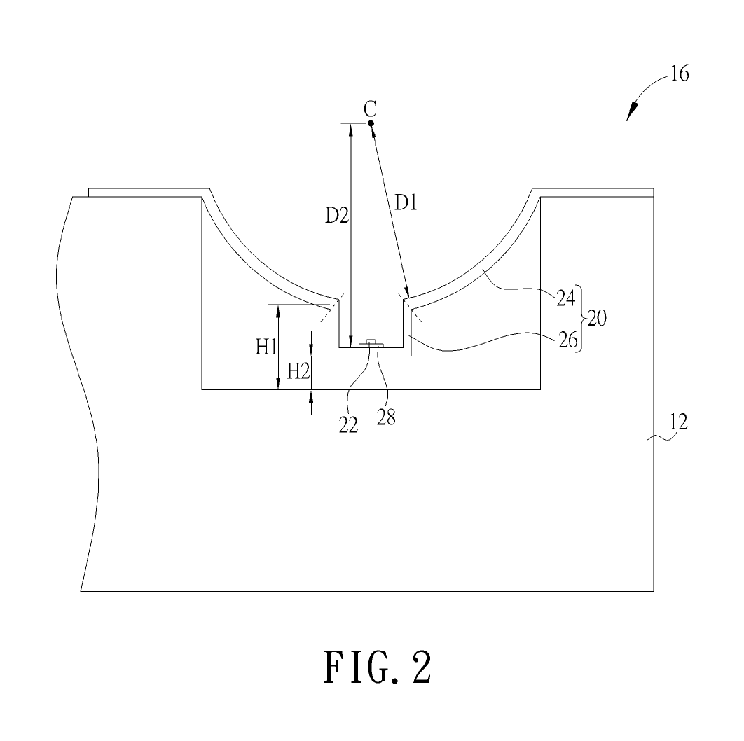

FIG. 2 is schematic cross-sectional view of a detection mechanism in accordance with an embodiment of the present invention. As shown, the detection mechanism 16 in the present embodiment includes a supporting member 20 and at least one detector 22. The supporting member 20 has a substantially symmetrical structure and is defined with a center point C. The supporting member 20 includes a first section 24 and a second section 26; wherein the first section 24 and the second section 26 are distinguished from each other by dashed lines, as illustrated in FIG. 2. The detector 22 is disposed in the second section 26. The center point C is the curvature center of the supporting member 20 when the inner surface of the supporting member 20 is arcuate in shape; however, the present invention is not limited thereto. The first section 24 has a first distance D1 to the center point C and the second section 26 has a second distance D2 to the center point C; wherein the second distance D2 is greater than the first distance D1.

From another viewpoint, the structural difference between the first section 24 and the second section 26 may be defined by using the base 12 as a reference. For example, the first section 24 has a first supporting height H1 relative to the base 12 and the second section 26 has a second supporting height H2 relative to the base 12; wherein the first supporting height H1 is greater than the second supporting height H2. As shown in FIG. 2, the second section 26 is disposed in the bottom area of the first section 24; accordingly, the print medium 18 will automatically move from the first section 24 to the second section 26 when is falling under gravity.

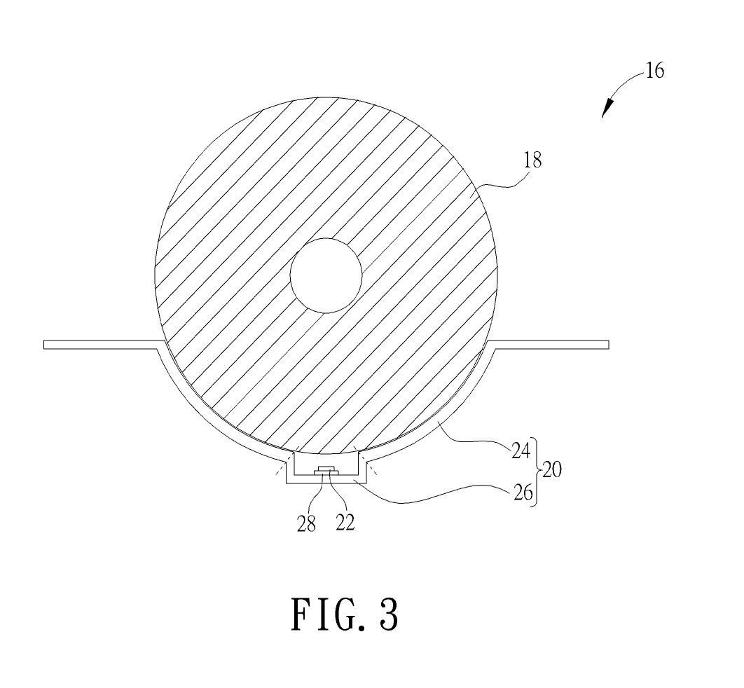

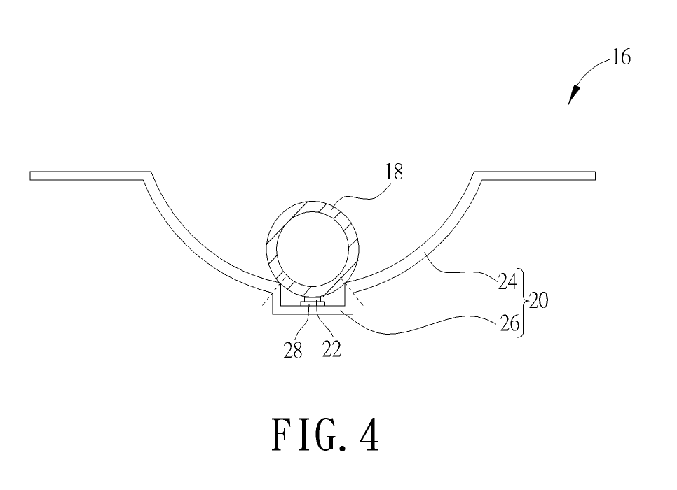

As described above, the detection mechanism 16 is configured to detect the remaining volume (or, the remaining size) of the print medium 18 and timely remind or alert a user to replace the print medium 18 according to the volume change of the print medium 18. Specifically, the detection mechanism 16 is configured to generate prompt or warning messages when the remaining volume (or, the remaining size) of the print medium 18 is down to a specific threshold. In general, the specific threshold is set to correspond to the 20˜30% of the initial volume (or, size) of the print medium 18; however, the specific threshold can be set to an amount based on an actual requirement and the present invention is not limited thereto. FIGS. 3, 4 are schematic cross-sectional views of a detection mechanism with a print medium loaded in accordance with an embodiment of the present invention. As illustrated in FIG. 3, when the remaining volume (or, the remaining size) of the print medium 18 is equal to or larger than a threshold, the print medium 18 is completely supported by the first section 24 of the supporting member 20. In other words, the print medium 18 is located in the first section 24 and has no physical contact with the second section 26. Alternatively, as illustrated in FIG. 4, when the remaining volume (or, the remaining size) of the print medium 18 is smaller than the specific threshold, the print medium 18 will automatically fall off into the second section 26 and has no physical contact with the first section 24. When detecting that the print medium 18 is located in the second section 26, the detector 22 generates a prompt message, such as “paper roll is about to run out”, on a screen panel (not shown).

In addition, as shown in FIGS. 2-4, the detection mechanism 16 may further include a position adjustment module 28, which is disposed on the supporting member 20 and is connected to the detector 22. The position adjustment module 28 is configured to control the height of the detector 22 relative to the second section 26; thus, the time of the detector 22 being triggered by the print medium 18 is correspondingly modulated. In other words, a user can change the specific threshold of the print medium 18 to an adjusted threshold by adjusting the height of the detector 22 relative to the second section 26 through the position adjustment module 28, thereby configuring the detection mechanism 16 to generate a prompt message when the remaining volume (or, the remaining size) of the print medium 18 is down to the adjusted threshold. The position adjustment module 28 is optional in the present invention. In addition, it is understood that any means capable of changing the height of the detector 22 relative to the second section 26 is within the spirit and scope of the position adjustment module 28 in the present invention, and no redundant detail is to be given herein.

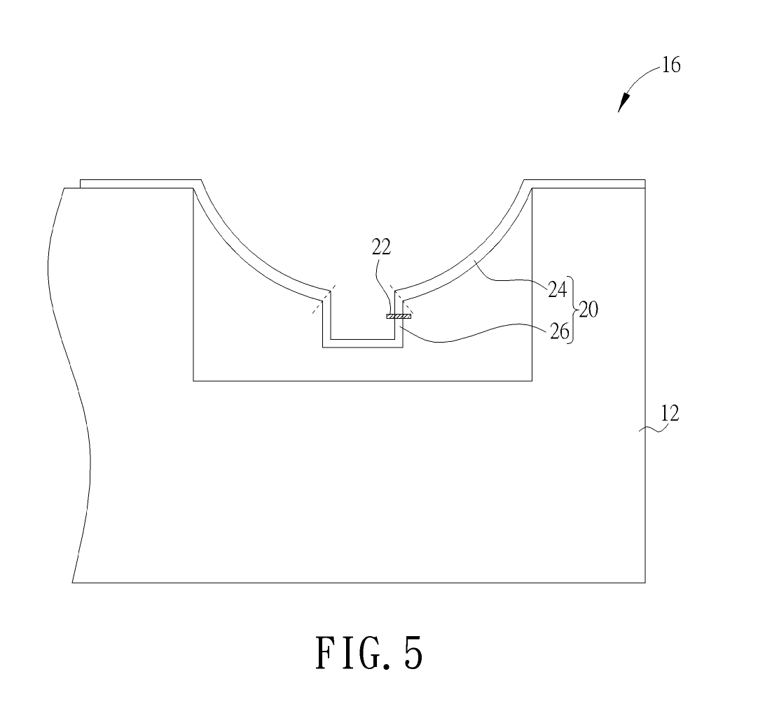

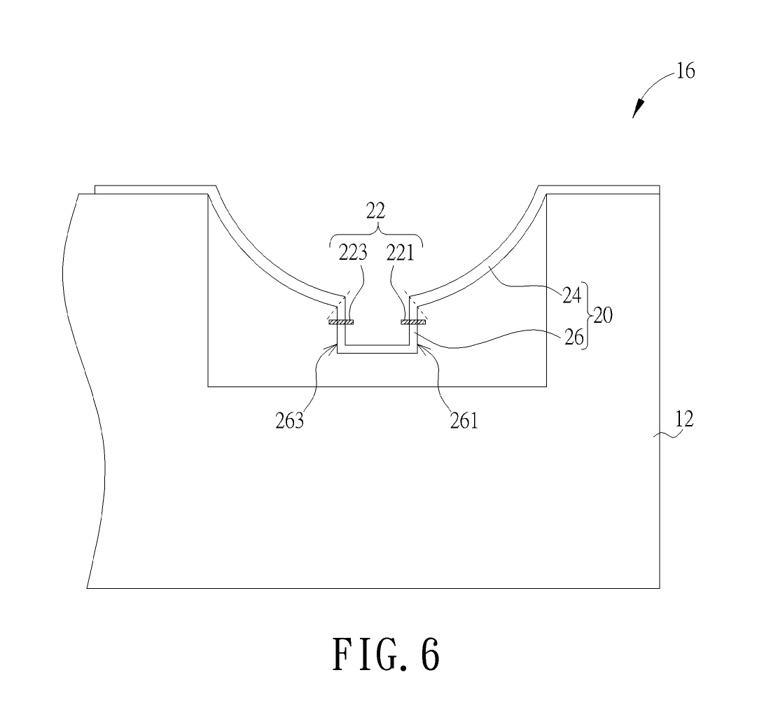

In the previous embodiments, the detector 22 may be implemented with a touch switch and correspondingly the detector 22 (a touch switch) is configured to generate a prompt message when is being touched and pressed by the print medium 18 located in the second section 26. FIG. 5 is a schematic cross-sectional view of a detector in accordance with another embodiment of the present invention. As shown, the detector 22 in the present embodiment may be implemented with a light transceiver, which is configured to output and receive light signals in the second section 26. Specifically, the transmission path of the light signal outputted from the detector 22 (a light transceiver) will be blocked by the print medium 18 when the print medium 18 is located in the second section 26; thus, the detector 22 (a light transceiver) generates a prompt message when receiving the light signal reflected by the print medium 18. FIG. 6 is a schematic cross-sectional view of a detector in accordance with still another embodiment of the present invention. As shown, the detector 22 in the present embodiment may be implemented with a light outputting unit 221 and a light receiving unit 223. The light outputting unit 221 is disposed at a first end 261 of the second section 26 and is configured to output a light signal. The light receiving unit 223 is disposed at a second end 263 of the second section 26 and is configured to receive the light signal outputted from the light outputting unit 221. The first end 261 and the second end 263 are two opposite ends of the second section 26. Specifically, the transmission path of the light signal outputted from the light outputting unit 221 will be blocked by the print medium 18 when the print medium 18 is located in the second section 26; thus, the detector 22 generates a prompt message if the light receiving unit 223 does not receive the light signal from the light outputting unit 221.

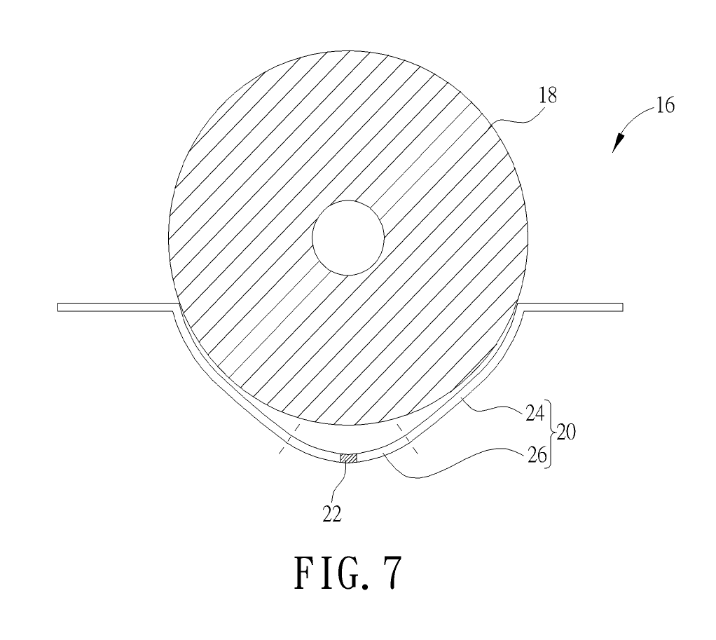

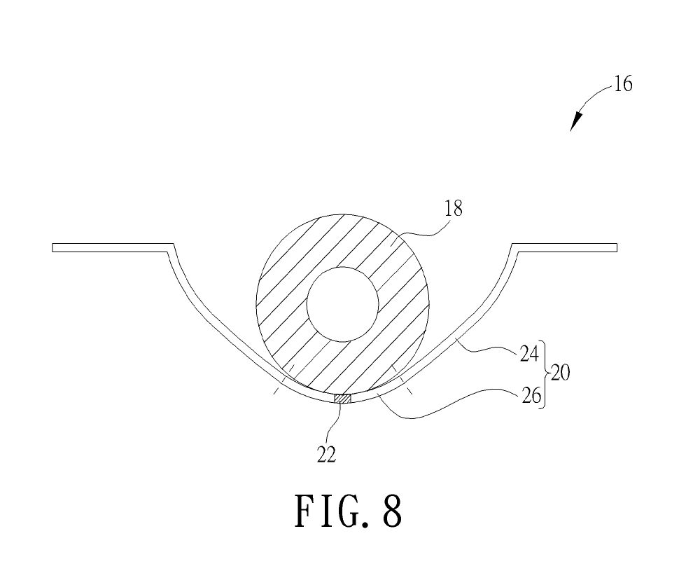

FIGS. 7, 8 are schematic cross-sectional views of a detection mechanism with a print medium loaded in accordance with another embodiment of the present invention. As shown, the first section 24 and the second section 26 of the support member 20 in the present embodiment have arcuate structures with different curvatures. For example, the first section 24 has a concave arcuate structure; and the second section 26 is further concaved, relative to the first section 24, at the bottom of the concave arcuate structure of the first section 24. In other words, the first section 24 has a first curvature and the second section 26 has a second curvature; wherein the second curvature is greater than the first curvature. Or, the first section 24 has a radius of curvature greater than that of the second section 26. As illustrated in FIG. 7, when the remaining volume (or, the remaining size) of the print medium 18 is equal to or larger than a threshold, the print medium 18 is completely supported by the first section 24 of the supporting member 20 and has no physical contact with the second section 26. Alternatively, as illustrated in FIG. 8, when the remaining volume (or, the remaining size) of the print medium 18 is smaller than the threshold, the print medium 18 is automatically fallen off into the second section 26 and is completely supported by the second section 26 of the supporting member 20. In addition, the detector 22 is triggered by the print medium 18 when the print medium 18 is fallen off into the second section 26.

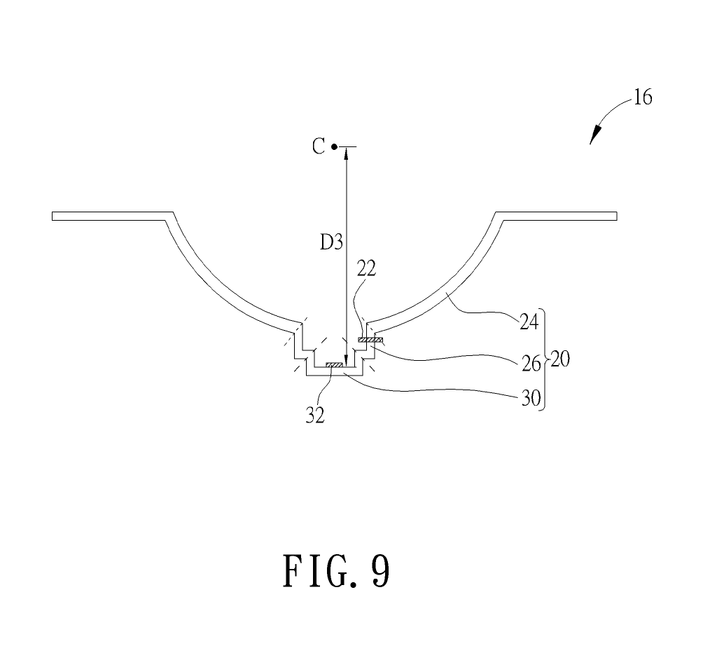

FIG. 9 is a schematic cross-sectional view of a detection mechanism in accordance with another embodiment of the present invention. As shown, the supporting member 20 in the present embodiment includes a first section 24, a second section 26 and a third section 30; wherein the first section 24, the second section 26 and the third section 30 are distinguished from one another by dashed lines. The third section 30 is disposed at the bottom of the second section 26 and has a third distance D3 to the center point C. Because the third section 30 is disposed at the bottom of the second section 26 and has a concave and flat-bottom structure, the third distance D3 is greater than the second distance D2. The detection mechanism 16 in the present embodiment may further include at least one sensor 32 disposed in the third section 30. Specifically, with the decrease of the remaining volume (or, the remaining size) of the print medium 18, the print medium 18 firstly is fallen off into the second section 26 from the first section 24 thereby triggering the detector 22 to generate a prompt message, such as “paper roll is about to run out”, on a screen panel. In addition, with the further decrease of the remaining volume (or, the remaining size) of the print medium 18, the print medium 18 is then fallen off into the third section 30 from the second section 26 thereby enabling the sensor 32 to generate a warning message, such as “paper roll is run out already”, on the screen panel.

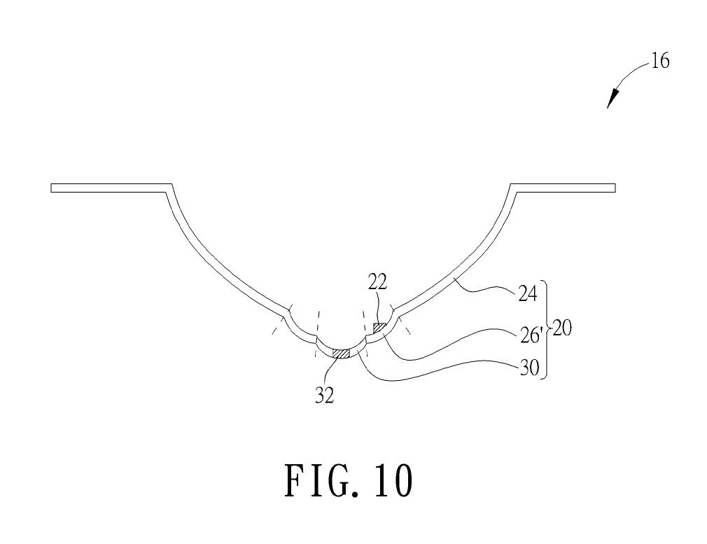

FIG. 10 is a schematic cross-sectional view of a detection mechanism in accordance with another embodiment of the present invention. As shown, the supporting member 20 in the present embodiment includes a first section 24, a second section 26′ and a third section 30; wherein the first section 24, the second section 26′ and the third section 30 are distinguished from one another by dashed lines. The first section 24, the second section 26′ and the third section 30 of the support member 20 in the present embodiment have arcuate structures with different curvatures. The third section 30 has a third curvature. As shown, because the third section 30 is further concaved, relative to the second section 26′, and is disposed at the bottom of the second section 26′, the third curvature of the third section 30 is greater than the second curvature of the second section 26′. Or, the second section 26′ has a radius of curvature greater than that of the third section 30. As illustrated in FIG. 10, with the decrease of the remaining volume (or, the remaining size) of the print medium 18, the print medium 18 firstly is fallen off into the second section 26′ from the first section 24 thereby triggering the detector 22 to generate a prompt message. Moreover, with the further decrease of the remaining volume (or, the remaining size) of the print medium 18, the print medium 18 is then fallen off into the third section 30 from the second section 26′ thereby enabling the sensor 32 to generate a warning message.

In summary, the supporting member in the present invention is divided into a first section and a second section. In one embodiment, specifically, the relative structure of the first and second sections is defined by that a second distance of the second section is greater than a first distance of the first section by using a center point as a reference; or the relative structure is defined by that a second height of the second section is smaller than a first height of the first section by using a base as a reference. In another embodiment, the first section has an arcuate structure and the second structure has a flat-bottom structure; or both of the first and second sections have arcuate structures. In other words, compared with the conventional supporting member, the supporting member in the present invention is designed to have a plurality of sections with specific structural characteristics (such as a distance to a center point or a height to a base). Thus, the print medium is located in different sections on the supporting member with the decrease of the remaining volume (or, the remaining size) of the print medium; and correspondingly a detector or a sensor can be triggered to remind or alter or alert a user to replace the print medium when the print medium is about to run out.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A detection mechanism configured to detect a position of a print medium, the detection mechanism comprising:
a supporting member, configured to support the print medium and defined with a center point, the supporting member comprising:
a first section, having a first distance to the center point; and
a second section, having a second distance to the center point, wherein the second distance is greater than the first distance; and
at least a detector, disposed in the second section and configured to generate a prompt message when detecting that the print medium is located in the second section,
wherein the print medium is located in the first section when the print medium has a size equal to or greater than a threshold, alternatively, the print medium is located in the second section when the size of the print medium is smaller than the threshold.

2. The detection mechanism according to claim 1, wherein the detector is a light transceiver, the light transceiver is configured to output a light signal in the second section and generate the prompt message when receiving the light signal reflected by the print medium.

3. The detection mechanism according to claim 1, wherein the detector comprises:
a light outputting unit, disposed at a first end of the second section and configured to output a light signal; and
a light receiving unit, disposed at a second end of the second section and configured to receive the light signal outputted from the light outputting unit,
wherein the first end and the second end are opposite to each other,
wherein the detector generates the prompt message if the light receiving unit does not receive the light signal.

4. The detection mechanism according to claim 1, wherein the detector is a touch switch, the touch switch generates the prompt message when is being touched and pressed by the print medium.

5. The detection mechanism according to claim 1, wherein the second section is disposed at the bottom of the first section, the first section has a first curvature and the second section has a second curvature, the first curvature is different with the second curvature.

6. The detection mechanism according to claim 5, wherein the second curvature is greater than the first curvature.

7. The detection mechanism according to claim 1, further comprising:
a position adjustment module, disposed on the supporting member and connected to the detector, the position adjustment module being configured to control a height of the detector relative to the second section.

8. The detection mechanism according to claim 1, wherein the supporting member further comprises a third section disposed in the second section, the third second has a third distance to the center point, the third distance is greater than the second distance, the detection mechanism further comprises at least a sensor disposed in the third section.

9. The detection mechanism according to claim 8, wherein the sensor is configured to generate a warning message when sensing that the print medium is located in the third section.

10. The detection mechanism according to claim 8, wherein the third section has a third curvature, the third curvature is greater than the second curvature, the third section is disposed at the bottom of the second section.

11. The detection mechanism according to claim 8, wherein the third section is disposed in a concave structure at the bottom of the second section.
